(19) United States
(12) Patent Application Publication
(10) Pub. No.: US 2015/0294396 A1
(43) Pub. Date: Oct. 15, 2015

(54) ITEM LOCATION INDICATION IN INDOOR ENVIRONMENT

(71) Applicants: Bruce Lewis Goodwin, Bryn Mawr, PA (US); Yiyang Joy Ding, New York, NY (US)

(72) Inventors: Bruce Lewis Goodwin, Bryn Mawr, PA (US); Yiyang Joy Ding, New York, NY (US)

(21) Appl. No.: 13/647,466

(22) Filed: Oct. 9, 2012

(51) Int. Cl. G06Q 30/06

(52) U.S. Cl. CPC G06Q 30/0639

(57) ABSTRACT

A floor plan of an indoor environment is provided to a mobile device in response to a request to access specific items in the environment. A user activates the mobile device to access the floor plan and the floor plan may be retrieved based on the mobile device's current location. The floor plan is displayed on the mobile device with indicators of locations where the requested items may be accessed. A path is also provided on the floor plan to indicate the direction that the user should follow to access each requested item. The path may be displayed as a number of path segments between the locations of the requested items. The path segments may indicate the shortest distance between the items such that the user can follow the most direct path to access the requested items.

### BACKGROUND

As mobile computing devices become more commonplace, users have become more reliant on location-based mobile applications to navigate their environment. Global Positioning System (GPS) technology is commonly used for providing directions to outdoor locations. Directions may be provided within indoor environments based on maps that have been processed to identify different routes in an indoor environment. However, mobile applications have not been developed to allow users to navigate to and access requested items at different locations within indoor environments.

### SUMMARY

Aspects of the present disclosure relate generally to providing directions to locations in an indoor environment where specific items may be accessed. A current location of a user's mobile computing device is identified and a map corresponding to an indoor environment at or near the current location is retrieved. The user may input an item or a list of items to be accessed in the indoor environment. The item(s) are matched to inventory listings associated with the indoor environment. The map is then returned to the user's device with indications of where the item(s) may be accessed in the indoor environment. The map may also indicate a path for the user to follow in the indoor environment such that each item may be accessed while traversing the shortest distance within the indoor environment.

In one aspect, a computer-implemented method, executed by a processor, includes receiving a request for at least one item from a mobile computing device, and receiving an identifier associated with the mobile computing device. A current location of the mobile computing device is also received. The current location of the mobile computing device is associated with an indoor environment. A floor plan corresponding to the indoor environment is accessed. A location indicator of a location on the floor plan where each requested item may be accessed is provided. A path is determined from the current location of the mobile computing device to the location of each requested item. A path indicator for the path indicates a shortest distance through the indoor environment from the current location of the mobile computing device to the location of each requested item. The floor plan is prepared using a processor. The floor plan includes the location indicators and the path indicator for display on the mobile computing device. The floor plan including the location indicators and the path indicator is transmitted to the mobile computing device based on the identifier.

In another aspect, a computer-implemented method, executed by a processor includes, receiving, as input to a mobile computing device, a list of items to be accessed in an indoor environment. The list of items, a current location of the mobile computing device, and an identifier associated with the mobile computing device are transmitted to a server. A map corresponding to the indoor environment is received at the mobile computing device. The map includes a location indicator corresponding to a location of each item in the indoor environment. The map also includes a path indicator for a path from the current location of the mobile computing device to the locations of the items to be accessed. The path indicator identifies a shortest distance through the indoor environment from the current location of the mobile computing device to the items to be accessed.

In another aspect, a system includes a memory and a processor. The memory stores a plurality of maps and a list of inventory of items accessible at specific indoor environments. Each map corresponds to an indoor environment. The list includes a location identifier of a location in the indoor environment where each corresponding item may be accessed. The processor is configured to receive a request for at least one item from a mobile computing device, and receive a current location of the mobile computing device. The current location of the mobile computing device is associated with a particular indoor environment. The processor is additionally configured to access from the memory a map corresponding to the particular indoor environment and, access from the memory the list of inventory of items associated with the particular indoor environment. The processor is further configured to identify the locations in the indoor environment where the requested items may be accessed using the location identifiers from the list of the inventory of items; and provide a location indicator of each location on the map where each requested item may be accessed. The indicator is positioned on the map based on the location identifier associated with the item. The processor determines a path from the current location of the mobile computing device to the locations of the requested items. A path indicator for the path indicates a shortest distance through the indoor environment from the current location of the mobile computing device to the locations of the requested items. The processor also prepares the map including the location indicators and the path indicator for transmission to and display on the mobile computing device.

### BRIEF DESCRIPTION OF THE DRAWINGS

FIG. 1 is a functional diagram of a system in accordance with an example embodiment.

FIG. 2 is a pictorial diagram of the system of FIG. 1.

FIG. 3 is a flow diagram in accordance with an example embodiment.

FIG. 4 illustrates a user interface of a mobile device showing a user input display.

FIG. 5 illustrates a user interface of a mobile device showing a map of an indoor environment that is output to the display.

FIG. 6 illustrates a user interface of a mobile device showing a user input display.

FIG. 7 illustrates a user interface of a mobile device showing a map of an indoor environment that is output to the display.

### DETAILED DESCRIPTION

The present disclosure is directed to providing a mobile device with a map of an indoor environment that includes indications of where requested items are located in the indoor environment. A current location of a user's mobile device is determined and a map of an indoor environment corresponding to the user's current location is identified. The user may input an item or list of items to be located in the indoor environment. The map is then provided to the user's device with indications of where each item is located in the indoor environment. The map may also indicate a path for the user to follow such that each item may be accessed by traversing the shortest possible distance in the indoor environment.

In one illustrative example, a user may disembark from an airplane at an airport terminal and have a limited amount of time before boarding a different airplane at the same terminal or a different terminal at that airport. The user may wish to obtain a newspaper, a toy for her child, and a vegetarian meal before boarding her next flight. The user may activate a feature on her mobile device that identifies her current location at a specific air terminal. The user may then be prompted to identify items to be accessed in the concourse of the terminal. The user might enter the following search terms: “New York Times,” “doll,” and “salad.” The user may also enter the departure gate of the connecting flight. In response, the user's mobile device may display a floor plan of the air terminal with an indication of a location where each of the requested items may be accessed. The floor plan may also be displayed with an indication of a path to navigate through the terminal such that the user may access each item and arrive at the boarding gate after traversing the shortest distance through the air terminal.

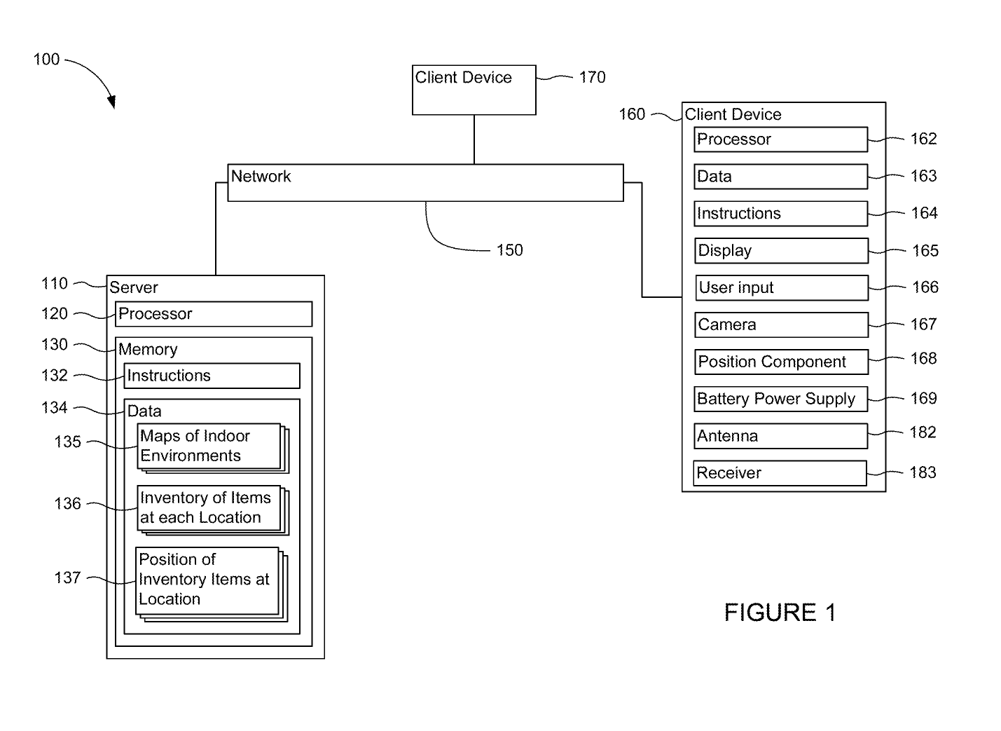

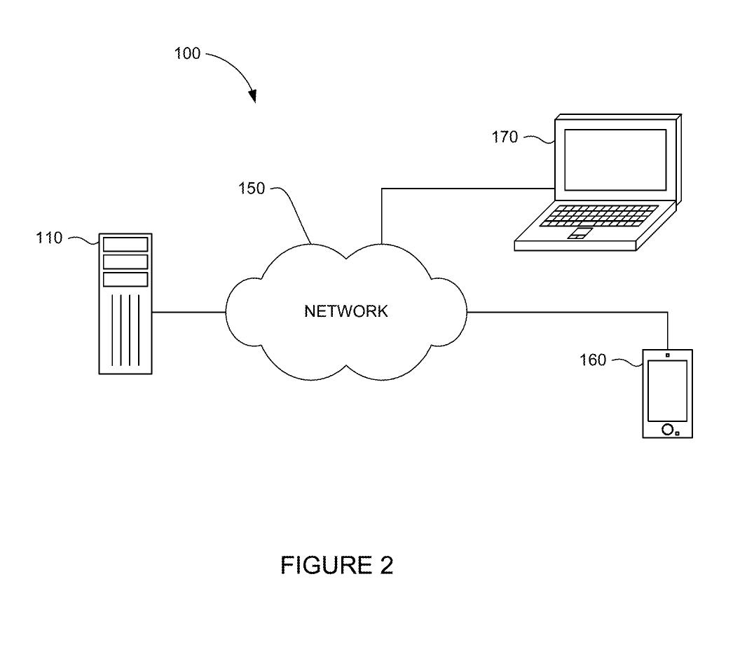

As shown in FIGS. 1 and 2, a system 100 in accordance with example embodiments includes a computer 110 containing a processor 120, memory 130 and other components typically present in general purpose computers. The memory 130 stores information accessible by the processor 120, including instructions 132 and data 134 that may be executed or otherwise used by the processor 120. The memory 130 may be of any type capable of storing information accessible by the processor 120, including a computer-readable medium, or other medium that stores data that may be read with the aid of an electronic device, such as a hard-drive, memory card, flash drive, ROM, RAM, DVD or other optical disks, as well as other write-capable and read-only memories. In that regard, memory may include short term or temporary storage as well as long term or persistent storage. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The data 134 may be retrieved, stored or modified by the processor 120 in accordance with the instructions 132. For instance, although the architecture is not limited by any particular data structure, the data may be stored in computer registers, in a relational database as a table having a plurality of different fields and records, XML documents or flat files. The data may also be formatted in any computer-readable format. By further way of example only, image data may be stored as bitmaps comprised of grids of pixels that are stored in accordance with formats that are compressed or uncompressed, lossless or lossy, and bitmap or vector-based, as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

The processor 120 may be any conventional processor. Alternatively, the processor 120 may be a dedicated controller such as an ASIC. Although FIG. 1 functionally illustrates the processor 120 and memory 130 as being within the same block, the processor and memory may actually comprise multiple processors and memories that may or may not be stored within the same physical housing. For example, memory may be a hard drive or other storage media located in a server farm of a data center. Accordingly, references to a processor, a computer or a memory will be understood to include references to a collection of processors or computers or memories that may or may not operate in parallel.

The computer 110 may be at one node of a network 150 and capable of directly and indirectly receiving data from other nodes of the network. For example, computer 110 may comprise a web server that is capable of receiving data from client devices 160, 170 via network 150 such that server 110 uses network 150 to transmit and display information to a user on display 165 of client device 160. Server 110 may also comprise a plurality of computers that exchange information with different nodes of a network for the purpose of receiving, processing and transmitting data to the client devices 160, 170. In this instance, the client devices 160, 170 will typically still be at different nodes of the network than any of the computers comprising server 110.

Network 150, and intervening nodes between server 110 and client devices 160, 170, may comprise various configurations and use various protocols including the Internet, World Wide Web, intranets, virtual private networks, local Ethernet networks, private networks using communication protocols proprietary to one or more companies, cellular and wireless networks (e.g., Wi-Fi), instant messaging, HTTP and SMTP, and various combinations of the foregoing. Although only a few computers are depicted in FIGS. 1 and 2, it should be appreciated that a typical system can include a large number of connected computers.

The client devices 160, 170 may include an antenna 182 and receiver 183 which may be used to scan the wireless network spectrum and identify local wireless network signals. For example, the antenna 182 may receive “beacon” messages and send them to the receiver 183 which demodulates the information to identify wireless network access points. In one example, these beacon messages may be IEEE 802.11 management frames transmitted by access points to announce themselves to potential wireless network users. These frames may contain Service Set Identifiers (“SSID”) information as well as physical layer parameters that assist devices in connecting to the wireless network. The beacon messages may also include additional network access information which also assists devices in accessing the network, including whether the access point is accepting new users, whether the data is encrypted, and which type of authentication is being used, for example, no authentication (open to all), password based, web-portable based, or Media Access Control (“MAC”) address based. However, it will be understood that data collected in accordance with this disclosure may be limited to the information discussed above, for example MAC addresses, SSIDs or other identifiers and signal strengths, and need not contain additional information. For example, information contained in the network traffic or payload data, such as personal information, need not be collected, and in fact, may actually be removed, encrypted or scrubbed in order to protect the privacy of the wireless network's users.

Users may be required to take an affirmative step in order to select or “opt-in” to participate. For example, users may be required to sign in to a service before providing any information and may be provided with an explanation of how and why their feedback is being used. Similarly, users may be provided with the opportunity to cease participation temporarily or permanently at any time. By requiring users to opt-in and sign in for the service, this may also reduce the amount of third parties attempting to spam the system. Over time, the system may determine whether the data provided by some users' devices is consistently at odds with that of other users, and disregard the information provided by inconsistent devices.

Each client device 160 may be configured similarly to the server 110, with a processor, memory and instructions as described above. Each client device 160 may be a personal computer intended for use by a person, and have all of the components normally used in connection with a personal computer such as a central processing unit (CPU) 162, memory (e.g., RAM and internal hard drives) storing data 163 and instructions 164, an electronic display 165 (e.g., a monitor having a screen, a touch-screen, a projector, a television, a computer printer or any other electrical device that is operable to display information), and user input 166 (e.g., a mouse, keyboard, touch-screen or microphone). The client device 160 may also include a camera 167, geographical position component 168, accelerometer, speakers, a network interface device, a battery power supply 169 or other power source, and all of the components used for connecting these elements to one another.

The geographical position component 168 may be used to determine the geographic location and orientation of the client device 160. For example, the geographical position component 168 may comprise a GPS receiver to determine the device's latitude, longitude and altitude. Thus, as the client device 160 changes locations, for example by being physically moved, the GPS receiver may determine a new current location. The position component 168 may also comprise software for determining the position of the client device 160 based on other signals received at the client device 160, such as signals received at a cellular phone's antennas from one or more cellular phone towers if the client device 160 is a cellular phone.

Although the client devices 160, 170 may each comprise a full-sized personal computer, they may alternatively comprise mobile computing devices capable of wirelessly exchanging data, including position information derived from position component 168, with a server over a network such as the Internet. By way of example only, client device 160 may be a wireless-enabled PDA, a cellular phone, a netbook or a tablet PC capable of obtaining information via the Internet or other network. The user may input information using a small keyboard, a keypad, voice recognition or a touch screen.

Data 134 of server 110 may include maps of indoor environments 135 that provide a graphic representation of specific areas accessible by users (e.g., a floor plan of an airport concourse or a shopping mall). Each map may be associated with a specific building or address. Data 134 of server 110 may also include a list of inventory of items 136 that are accessible by users at locations in each area represented by the map. Data 134 of server 110 may further include information about a position of specific items of inventory in each area represented by the map.

The list of inventory and corresponding positions may be acquired in different ways. In one example, a retail establishment may provide the listing and position of inventory accessible at each physical store location. In another example, a distributor may provide the inventory information based on items sent to a retail store and the retail store could update the inventory quantities as items are sold. In a further example, images may be captured of each retail establishment by an image capturing device that moves around the retail store. These images may be used to identify the type and position of inventory in the store.

In addition to the operations described below and illustrated in the figures, various operations in accordance with example embodiments will now be described. It should also be understood that the following operations do not have to be performed in the precise order described below. Rather, various steps can be handled in a different order or simultaneously, and may include additional or fewer operations.

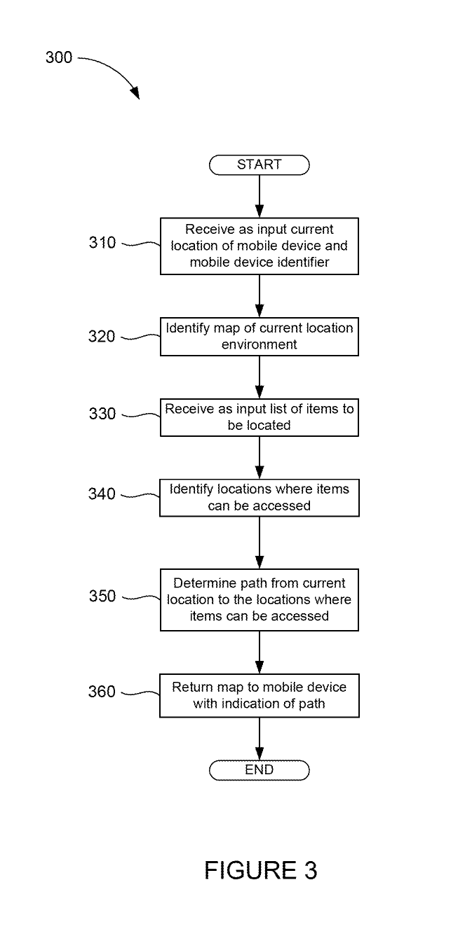

FIG. 3 demonstrates a process 300 of providing a map of an indoor environment to a user's mobile device with an indication of a path to follow to locations where requested items may be accessed in the indoor environment. The process 300 begins when a user activates a feature on his mobile computing device to request a floor plan of a current location where items are to be accessed. The activation of the feature causes a current location of the device and an identifier of the device to be provided to and received at a server (block 310). In one illustrative example, the user may be at or near an entrance to an indoor shopping mall.

In response to receiving the current location of the device, the server identifies a map associated with an environment at or near the current location (block 320). The server may identify the map in memory that stores a large number of different maps each associated with a particular location. The map that is identified may be a floor plan of a building that is closest to the current location of the mobile device. For example, if the current location of the device is just outside a shopping mall, the map that is identified is a floor plan of the shopping mall that the mobile device is near. The map may be identified using the current location of the device and a known address located at or near the device's current location.

The user may be prompted to input items to be accessed from the environment. In response to the prompt, the user inputs the desired items into the mobile device, and a list of the items is received at the server (block 330). The prompt may correspond to the type of floor plan identified as corresponding to the current location of the mobile device. Using the shopping mall example, the user may be prompted to enter the items to be purchased at the shopping mall. Then the user may enter the items from a shopping list (e.g., “men's socks,” “toner cartridge for printer,” “DVD,” “art supplies,” and “jewelry.” These search terms are then provided to the server.

In response to receiving the search terms, an indication is made on the map of a location where each of the items may be accessed (block 340). The different locations on the map that correspond to positions where items may be accessed may each be tagged with terms that correspond to inventory available at those locations. In some implementations, any location where the item may be accessible is indicated on the map. In other implementations, only the locations that correspond to a popular location are indicated on the map. In a shopping mall, the following types of stores might be indicated as locations where the requested items may be found: men's clothing stores, department stores, pharmacies, electronics stores, hobby shops, office supply stores, and jewelry stores. The indication on the map may also include a designation of the search term that resulted in the particular location being highlighted on the map. For example, the electronics store may include a designation that indicates that both DVDs and toner cartridges may be available in the electronics store. In addition, the floor plan of the electronics store may include separate indicators for the different locations where DVDs and toner cartridges may be accessed.

In some implementations, if more than one location is identified as having a particular item, the user may be prompted to identify a preferred location for obtaining the item. For example, the mobile device may indicate that men's socks are available from three different department stores, four men's clothing boutiques, a store that sells only socks, and two different pharmacies. In this case, the user may select one or more of the locations where men's socks are available.

After the different locations where the items are accessible are identified on the map, a determination is made of the path from the user's current location to locations where the requested items are accessible (block 350). In some implementations, the path follows the shortest distance between the current location and the locations where the items are accessible. For example, the path may start at the user's current location in the shopping mall and continue to a pharmacy (with an indication of “men's socks” and “art supplies”), a department store (with an indication of “jewelry” and “men's socks”), and an electronics store (with an indication of “toner cartridge for printer” and “DVD”).

The path may also indicate the locations within each store where the different items may be accessed. For example, the electronics store may be provided on the map with one indication where the toner cartridges are located and a different indication where the DVDS are located. The map is then returned for display on the user's mobile device such that the user may navigate the indoor environment and access the requested items (block 360).

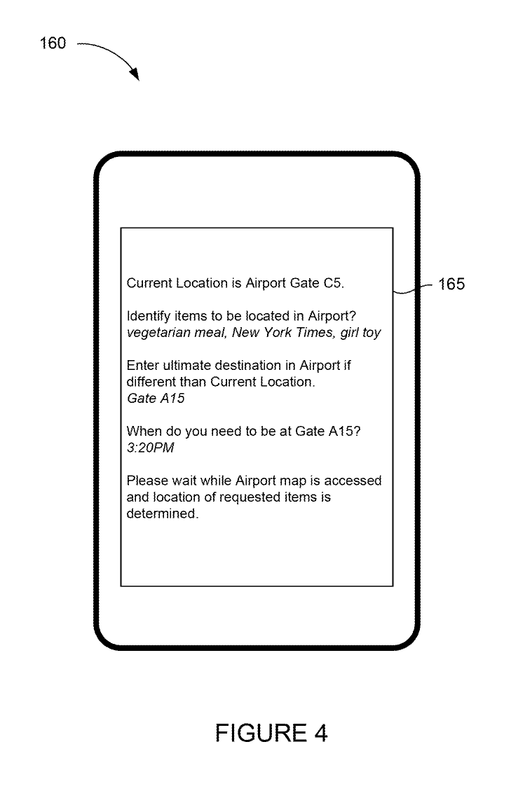

FIG. 4 illustrates a user interface of a mobile device showing a user input display. The user may activate the mobile device 160 to navigate an unfamiliar indoor area where the user desires to access certain items. Using an airport terminal as an example of an indoor environment, the user may activate the indoor navigation feature of the mobile device 160 when the user disembarks from an airplane at a gate. The user's current location may be determined and displayed on the user interface display 165. As shown in the figure, the user's current location is identified as “Airport Gate C5.”

The user is then prompted to input items to be accessed in the Airport. The user may input the items to be accessed as text. In some implementations, the user may select entries from a menu of items that are known to be available in the Airport. The menu could be provided by any retail establishment that sells items in the Airport. As shown in the drawing, the user entered the following search terms: “vegetarian meal,” “New York Times,” and “girl toy.”

Since the user's current location is known to be the Airport, the application may prompt the user about supplemental locations where the user may need to be present but where items are not purchased. Examples of supplemental locations include a boarding gate for a connecting flight, a passport/customs clearance area, or a shoe shine station. If the user needs to access a supplemental location, this information will be taken into account when determining the user's navigation path. In this example, the user inputs that his connecting flight leaves Gate A15 at 3:20 PM. The search terms and the supplemental location information are then forwarded to a server for processing.

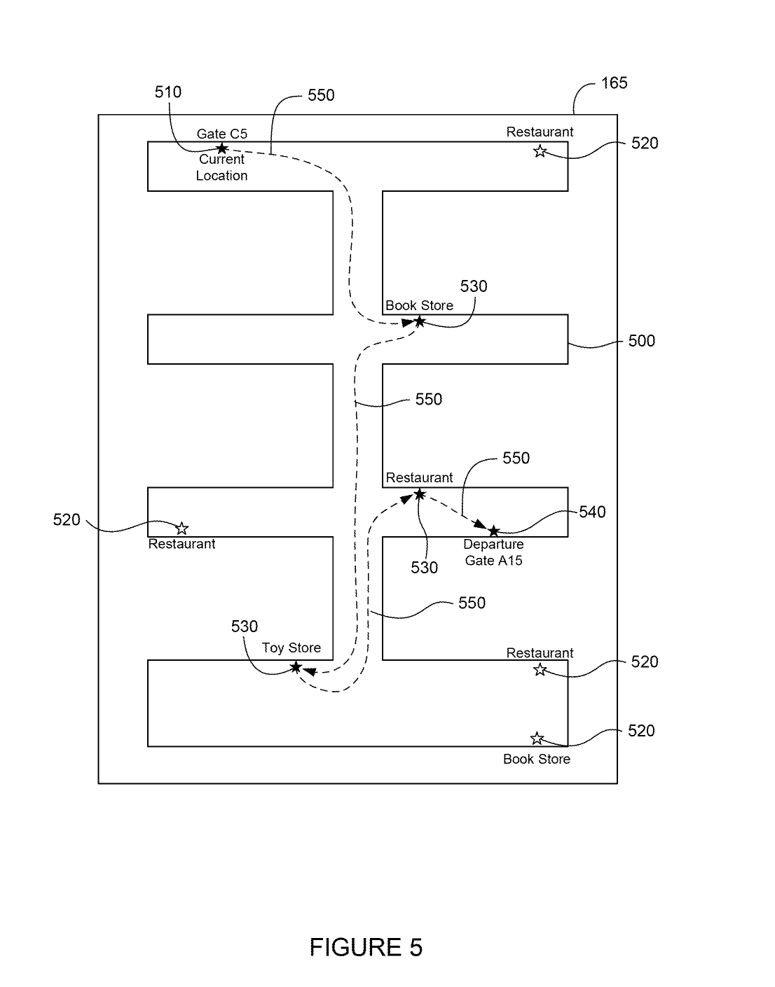

FIG. 5 illustrates a user interface of a mobile device showing a map of an indoor environment that is output to the display. The indoor environment is illustrated as a floor plan 500 of the Airport. The user's current location is identified on the map with an indicator 510. Other indicators 520, 530 identify areas where items corresponding to the search terms can be accessed, and still other indicators 540 identify supplemental locations.

The locations where a requested item can be accessed in the Airport may be identified. Since the same item can be accessed from different locations, the application performs a process to determine a path from the user's current location to a final desired location such that the user can access the requested items by traversing the shortest distance through the Airport. Accordingly, the floor plan 165 is displayed with path segments 550 from the user's current location indicator 510 to each indicator 530 that corresponds to a location where a requested item may be accessed. The last path segment 550 provides a path to the user's last destination, departure Gate A15, as symbolized by indicator 540. The other indicators 520 correspond to locations where the items could be accessed but these locations would result in a longer distance from the user's initial location (Gate C5) to the user's final location (Gate A15). Accordingly, these locations are not included as part of the path provided on the floor plan 165.

In some implementations, the context of the locations and requested items may be taken into account to determine the order with which the locations are provided on the path. For example, a user moving through an airport terminal would likely want to eat just prior to boarding the aircraft and would presumably want to eat near the boarding gate within earshot of any public announcements made by the flight attendants. Therefore, the path would lead the user from his current location to the location where the requested items could be purchased before directing the user to a restaurant near the departure gate.

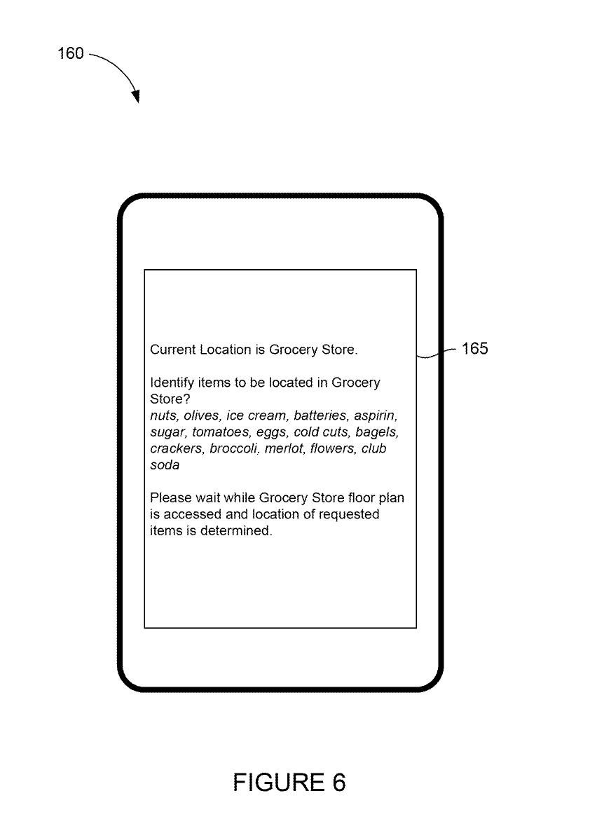

FIG. 6 illustrates a user interface of a mobile device showing a user input display. The user may activate the mobile device to identify locations of items in a specific environment. In response to activation of the application, the current location of the mobile device is identified. For example, the user's current location may be recognized as being in or near a grocery store. The user may then be prompted to identify items to locate in the specific area. For example, the user may submit as input a grocery list. Specifically, the user may input the following search terms: “nuts,” “olives,” “ice cream,” “batteries,” “aspirin,” “sugar,” “tomatoes,” “eggs,” “cold cuts,” “bagels,” “crackers,” “broccoli,” “merlot,” “flowers,” and “club soda.” These search terms are submitted to the server along with the user's current location and an identifier of the mobile device. The server accesses a floor plan corresponding to the user's current location (e.g., the Grocery Store) and identifies the location of each requested item on the floor plan.

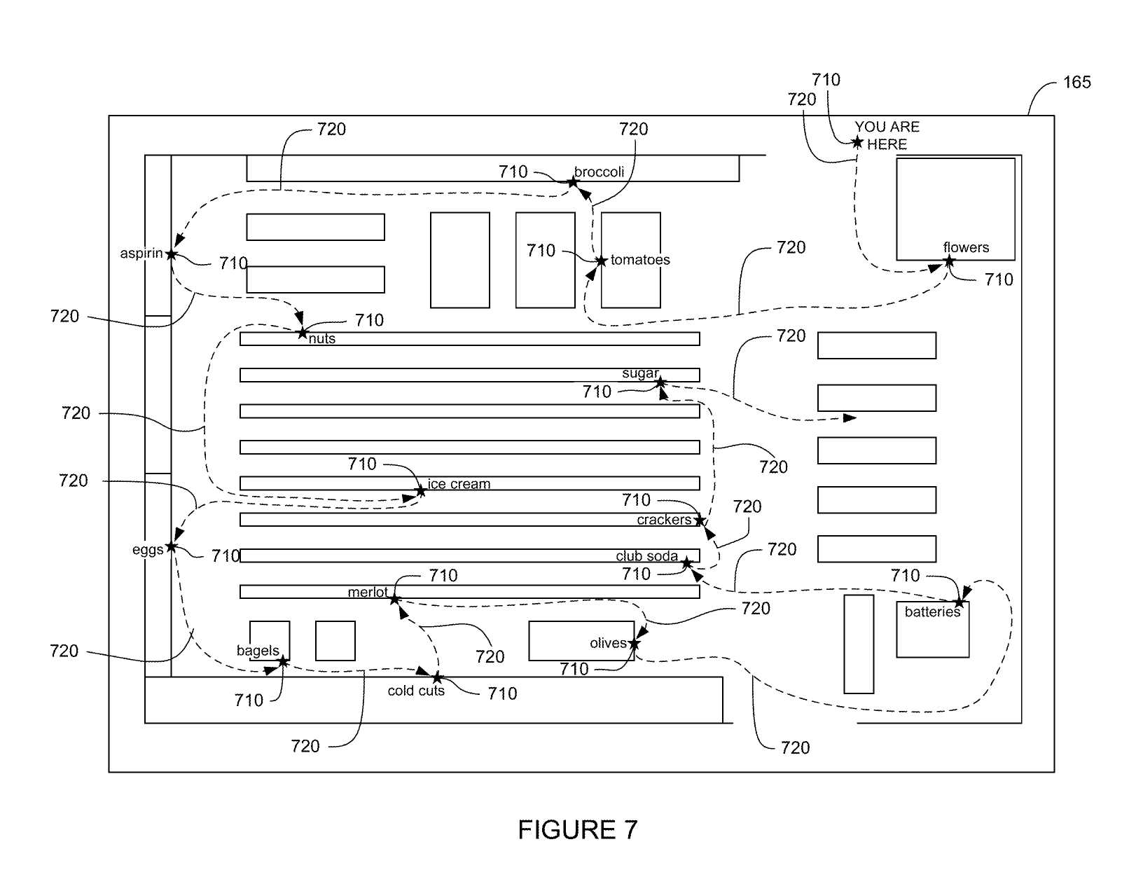

FIG. 7 illustrates a user interface of a mobile device showing a map of an indoor environment that is output to the display. A floor plan of the Grocery Store is forwarded to the user's mobile device and output to the display 165. The location of each requested item and the mobile device's current location are marked on the floor plan with an indicator 710. A text label may be provided proximate each indicator 710 so that the user is informed about which requested item can be accessed at the location. A path is also provided on the floor plan indicating the direction that the user should follow through the Grocery Store to access each requested item. The path is shown on the floor plan as a number of path segments 720 connecting the different locations of the requested items. In some implementations, the path segments 720 are displayed on the floor plan to provide the shortest overall path to each requested item such that the user can access each item by traversing the shortest distance through the indoor environment.

As these and other variations and combinations of the features discussed above can be utilized without departing from the scope of the claims, the foregoing description of exemplary embodiments should be taken by way of illustration rather than by way of limitation as defined by the claims. It will also be understood that the provision of example embodiments (as well as clauses phrased as “such as,” “e.g.”, “including” and the like) should not be interpreted as being limited to the specific examples; rather, the examples are intended to illustrate only some of many possible aspects.

1. A computer-implemented method executed by one or more processors, the method comprising:
receiving a request for a plurality of items from a mobile computing device, each item being associated with an action specific to an indoor environment, wherein a first item is associated with a first action and a second item is associated with a second action different from the first action;
receiving an identifier associated with the mobile computing device;
receiving a current location of the mobile computing device, wherein the current location of the mobile computing device is associated with the indoor environment;
accessing a floor plan corresponding to the indoor environment;
determining, using the one or more processors, at least one location of each of the plurality of items;
determining, using the one or more processors, an order of the plurality of items based on one or more constraints related to performing the actions;
determining, using the one or more processors, one or more possible paths from the current location of the mobile computing device to a location of each of the plurality of items based at least in part on the order of the plurality of items;
determining, using the one or more processors, a shortest path of the one or more possible paths, wherein a path indicator for the path indicates a shortest possible distance through the indoor environment from the current location of the mobile computing device to the location of each of the plurality of items;
preparing the floor plan using the one or more processors, wherein the floor plan includes the location indicators and the path indicator for display on the mobile computing device; and
transmitting the floor plan including the path indicator to the mobile computing device based on the identifier.

2. The computer-implemented method of claim 1, wherein the path indicator comprises a plurality of path segments, each path segment indicating a direction to follow the path to access one of the plurality of items.

3. The computer-implemented method of claim 1, further comprising accessing a memory to identify the location in the indoor environment where each item of the plurality of items may be accessed.

4. The computer-implemented method of claim 1, further comprising receiving a list of inventory of items accessible in the indoor environment, wherein the list includes a location identifier of a location in the indoor environment where a corresponding item may be accessed, the list being accessed to determine a position of each location indicator on the floor plan.

5. The computer-implemented method of claim 4, further comprising receiving an update to the list of inventory of items.

6. The computer-implemented method of claim 1, further comprising receiving a supplemental location from the mobile computing device, wherein an indication of the supplemental location is provided on the floor plan, the supplemental location not corresponding to one of the plurality of items.

7. A computer-implemented method executed by one or more processors, the method comprising:
receiving, as input to a mobile computing device, a list of items to be accessed in an indoor environment, each item being associated with an action specific to an indoor environment, wherein a first item is associated with a first action and a second item is associated with a second action different from the first action;
transmitting the list of items, a current location of the mobile computing device, and an identifier associated with the mobile computing device to a server;
determining, using the one or more processors, at least one location of each item from the list of items;
determining, using the one or more processors, an order of the list of items based on one or more constraints related to performing the actions;
determining, using the one or more processors, one or more possible paths from the current location of the mobile computing device to a location of each item from the list of items to be accessed based at least in part on the order of the list of items;
determining, using the one or more processors, a shortest path of the one or more possible paths;
receiving, at the mobile computing device, a map corresponding to the indoor environment, wherein the map includes:
a path indicator for a path from the current location of the mobile computing device to the locations of each item from the list of items to be accessed, wherein the path indicator identifies a shortest possible distance through the indoor environment from the current location of the mobile computing device to the locations of each item from the list of items to be accessed.

8. The computer-implemented method of claim 7, wherein the path indicator comprises a plurality of path segments, each path segment indicating a direction to follow the path to access one item from the list of items to be accessed.

9. The computer-implemented method of claim 7, further comprising receiving, as an additional input to the mobile computing device, a supplemental location that does not correspond to an item on the list of items to be accessed, wherein the map includes an indication of the supplemental location.

10. A system comprising:
a memory storing:
a plurality of maps, wherein each map corresponds to an indoor environment, and
a list of inventory of items accessible at specific indoor environments; and
a processor configured to:
receive a request for a plurality of items from a mobile computing device, each item being associated with an action specific to a particular indoor environment, wherein a first item is associated with a first action and a second item is associated with a second action different from the first action;
receive a current location of the mobile computing device, wherein the current location of the mobile computing device is associated with the particular indoor environment;
access from the memory a map corresponding to the particular indoor environment;
access from the memory the list of inventory of items associated with the particular indoor environment;
determine at least one location of each item of the plurality of items in the indoor environment;
determine an order of the plurality of items based on one or more constraints related to performing the actions;
determine one or more possible paths from the current location of the mobile computing device to a location of each item of the plurality of items based at least in part on the order of the plurality of items;
determine a shortest path of the one or more possible paths, wherein a path indicator for the path indicates a shortest possible distance through the indoor environment from the current location of the mobile computing device to the locations of the plurality of items; and
prepare the map including the path indicator for transmission to and display on the mobile computing device.

11. The system of claim 10, wherein the processor is further configured to:
receive an identifier associated with the mobile computing device; and
transmit the map including the location indicators and the path indicator to the mobile computing device based on the identifier.

12. The system of claim 10, wherein the processor is further configured to update the list of inventory of items.

13. The system of claim 10, wherein the processor is further configured to receive a supplemental location from the mobile computing device, wherein an indication of the supplemental location is provided on the floor plan, the supplemental location not corresponding to one of the plurality of items.

14. The computer-implemented method of claim 1, further comprising determining one or more supplemental locations based at least in part on the indoor environment, wherein the supplemental locations include locations related to at least one of a service and transportation.

15. The computer-implemented method of claim 7, further comprising determining one or more supplemental locations based at least in part on the indoor environment, wherein the supplemental locations include locations related to at least one of a service and transportation.

16. The system of claim 10, wherein the processor is further configured to determine one or more supplemental locations based at least in part on the indoor environment, wherein the supplemental locations include locations related to at least one of a service and transportation.
